(19) United States
(12) Patent Application Publication
(10) Pub. No.: US 2009/0207963 A1
(43) Pub. Date: Aug. 20, 2009

(54) NUCLEAR REACTOR

(75) Inventor: Gerrit Clemens Van Uitert, Voorschoten (NL)

Correspondence Address: DARBY & DARBY P.C., P.O. BOX 770, Church Street Station, New York, NY, 10008-0770, US

(73) Assignee: Vera Van Uitert-Zoet, Voorschoten (NL)

(21) Appl. No.: 12/301,562

(22) PCT Filed: May 16, 2007
(86) PCT No.: PCT/NL07/50226

§ 371 Date: Jan. 22, 2009

(30) Foreign Application Priority Data
May 19, 2006 (NL) 2000078

(51) Int. Cl. G21C 1/16; G21C 11/06; G21C 11/08

(52) U.S. Cl. 376/402

(57) ABSTRACT

The present invention generally relates to a nuclear reactor, comprising a reactor core, neutron reflectors surrounding the core on all sides, uranium oxide as reactor fuel and a coolant that is liquid at proces conditions and solid at room temperature. The invention is characterized in that the nuclear reactor comprises a thermal isolation which is impermeable for the coolant, which is of a different material than the coolant and which has a melting point higher than the temperature in the reactor, in such a way that the thermal isolation is surrounding the reactor core and the neutron reflectors on all sides in order to provide a leak-tight containment function. Therefore the phenomenon is being used that the temperature on the outside of the installation is always far below the melting point of the coolant, in such a way that the coolant solidifies on the outside of the installation under all possible circumstances. The heating channels, which are preferably embedded in the reflectors, contain heating elements for heating the reactor core to a temperature higher than the melting point of the coolant before the reactor is filled with the coolant and before the start up of the reactor begins. The whole primary system of the installation may fit in a transportable container.

The present invention generally relates to a nuclear reactor, comprising a reactor core, graphite reflectors surrounding said core, uranium oxide as reactor fuel and a cooling medium that is liquid at proces conditions and solid at room temperature. The invention particularly, but not exclusively, relates to a primary system, comprising the reactor core and heat exchanger e.g. steam generator, of a thermal nuclear power plant, in this description referred to as building block reactor (BBR).

The BBR is a nuclear (micro)reactor which is inherently safe. This means that under no circumstances radioactive fission products can be released from the reactor core, because its internal maximum temperature is limited by nature on basis of a deterministic approach. This characteristic corresponds to that of the German HTR-M (High Temperature Reactor—Module) because both types use the same design philosophy and the same type of fuel. This fuel is uranium dioxide fuel embedded in coated TRISO particles which do not release any fission products up to about 1600° C. However, the HTR-M is not a microreactor.

Examples of other microreactor types are Toshiba 4S (Super Safe, Small & Simple), ENHS (Encapsulated Nuclear Heat-Source) and the STAR-LM (Secure Transportable Autonomous Reactor—Liquid Metal). Both latter types are being developed under US NERI (Nuclear Energy Research Initiative). Characteristically for these examples is that they all are fast reactors. That means that the neutrons causing the fissions in these reactors are not slowed down. They use plutonium as fissile material (with a weight percentage 30 between 10 and 20%) and natural or depleted uranium as fertile material. Only the core of the reactors may be placed in transportable containers. Another characteristic is that they are liquid metal cooled, viz. sodium or lead or lead/bismuth. They may be cooled by natural circulation. If a small break occurs in their primary systems, then leakage of their coolants may happen. Their power level is typically between 10 MWₑ and 50 MWₑ.

A technology was developed both for sodium cooled reactors and for molten salt cooled reactors (FR 2 684 789) to seal the liquid coolant. Characteristically for this technology is that a layer of solid coolant is kept solidified against the wall of the reactor and is maintained by an active cooling system. In fact such a sealing layer of solid coolant may also be considered to be an isolating layer.

A similar method has been mentioned in the Belgium patent application BE 728799 where a part of the coolant is deposited to the wall as a solid layer and where it is maintained by an active cooling system. The coolant penetrates through a specially provided isolation layer which is fixed to the reactor's impermeable concrete wall. The British patent application GB 512771 concerns a furnace which has a wall with such a thickness that the material to be melted is contained in the furnace. However this patent does not concern a nuclear reactor and the size of the parasitic heat flow has no relevance contrary to the BBR where it is of paramount relevance. The BBR can be considered a thermal microreactor, however using low-enriched uranium as fuel. Thermal means that the neutrons causing the fissions in the reactor are slowed down until they nearly are in thermal equilibrium with the reactor core material.

The nuclear reactors known from the state of the art suffer from several problems. The known inherently safe reactors are large reactors, both with respect to their power output and to their physical dimensions. The micro reactors known in the art suffer from the problem that they are not inherently safe.

It is an object of the present invention to provide an improved thermal nuclear reactor.

It is a further object to provide a nuclear reactor that is inherently safe and easy to handle.

It also is an object to provide a nuclear reactor that can be installed and used both alone and in parallel with other such reactors.

The present invention provides at least one of these objects with a reactor as mentioned in the preamble and that is characterized in that the nuclear reactor comprises a thermal isolation which is impermeable for the coolant, which is of a different material than the coolant and which has a melting point higher than the temperature inside the reactor, such that the reactor core and its neutron reflectors are surrounded by the thermal isolation on all sides in order to provide a leak-tight containment near a wall of a housing of the nuclear reactor. In combination with the kind of coolant, a leak-tight reactor is obtained. If any leakage of coolant would occur, this will solidify before reaching the outside of the reactor. This way the solidifying characteristic of the cooling medium is used since the temperature of the housing will be near room temperature. This is well below the solidification point of the cooling medium. Preferably, the thermal isolation surrounds the core and its neutron reflectors that are positioned on the sides, the top and the bottom of the core. The solidification point is for the BBR situated inside the isolating material which is positioned between the outer neutron reflector and the container wall.

Contrary to the method in FR 2 684 789 the size of the parasitic heat flow is important because this heat flow should be set in such a way that in the case of a break-down of the secondary cooling, being the supply of the feed water to the steam generator, the reactor core will be cooled by the heat flow through the wall. By this the temperature on the hottest spot in the reactor will always be lower than the safe value of 1600° C., such that the radioactive fission products remain confined in the core.

The confinement of the coolant of the BBR differs in this respect from the nuclear reactors known from the state of the art in such a way that there is neither a layer of solid coolant present, nor an active cooling system. The cooling of the outer wall of the container which contains the primary system of the BBR occurs by means of mainly passive cooling, for example by placing the container in a pool filled with water, or for example in case of a dry solution by free convection cooling by air flowing upwards as well as by heat radiation.

According to a further preferred embodiment, heating elements are embedded in the reflector for heating at least the reactor core before start up of the reactor. By this measure, the overall dimensions of the reactor can be kept very small.

According to a still further preferred embodiment, heating channels are embedded in the reflectors, said channels containing the heating elements. The reactor core and channels through which cooling medium flows can be heated to a temperature higher than the melting point of the cooling medium before the reactor is filled with the cooling medium and before the start up of the reactor begins.

Other preferred embodiments are subject of the remaining dependent claims. The advantages provided will be clear to a person skilled in the art after reading this description and with reference to the figures of the drawing.

Differences between the BBR and the other microreactor types as mentioned above are the type of fuel (low-enriched uranium, respectively plutonium/uranium) and the neutron spectrum in the reactor (thermal, respectively fast).

The HTR-M as mentioned above is an inherently-safe thermal reactor. However, it is not a micro reactor. The HTR-M power level is about 80 MWe per unit. The HTR-M has a reactor core consisting of a fixed bed of pebble-like fuel elements. This reactor type is therefore called pebble bed reactor. The reactor is helium cooled which requires a very high leak tightness of all primary systems. It requires an active cooling system which includes a helium pump. The reactor is placed in a thick-walled reactor vessel inside a reactor room. The steam generator is in an adjacent room. Refuelling takes place during normal operation during which burned-up pebble fuel elements are replaced by new ones. The HTR-M uses low-enriched uranium, viz. up to 10%.

The nuclear fuel in the BBR is contained in prismatic fuel elements. Both BBR and HTR-M possess the characteristic that their temperature dependent reactivity coefficient is always negative, as well as their power dependent reactivity coefficient. This means that nature shuts the reactor down in the case of a loss of coolant from the secondary system, e.g. loss of coolant water from the steam generator, as long as the amount of excess reactivity is absent or small. The reactor cores in both types of reactor can never reach a temperature (higher than 1600° C.) during which radioactive products would be released. Both types are cooled completely passively by heat conduction from the core to the outer wall(s) and by natural circulation of air along these outer wall(s) after a loss of secondary coolant incident.

Any other High Temperature Reactors have a large excess reactivity and/or a power level above 100 MWₑ.

Differences between HTR-M and BBR are, among others, the type of refuelling (continuous respectively batch-wise viz. at End of Life) and the type of fuel elements (pebbles respectively prismatic).

In the following an example is presented of a BBR. It turns out that there is quite a large freedom in the selection of the relevant design parameters, like its dimensions. This feature permits that a line of such reactors can be developed. In the case which is presented hereafter, the BBR possesses a continuous power level in the order of 30 MWₜₕ or about 10 MWₑ (typically between 10 MWₜₕ and 100 MWₜₕ) during the whole operating period. In any case the hottest place in the BBR is always below 1600° C. Consequently, its maximum coolant temperature will always be below about 1200° C.

Hereafter, a few features concerning the present invention are mentioned. However, the invention is not limited to the combination of features as indicated here. The invention is only limited by the appended claims. Each feature may be combined with any separate feature as a person skilled in the art will understand is possible and safe:

1) The BBR is a liquid metal cooled thermal reactor using low-enriched uranium as fuel (LEU up to 20%) with batch wise refuelling. Its primary system is placed in a transportable container. The BBR is inherently safe. This means that no reactivity excursion can happen because only a very small amount of excess reactivity is present in the core of the reactor (about 1.3% at maximum) during its operating period. Consequently the accidents which occurred in Harrisburg and Tsjernobyl can impossibly happen in a BBR. Up to now there is no such reactor like the BBR with this combination of characteristics;

2) The BBR is extremely simple in every respect, which means that:

A. The primary system of the BBR is encased in a large container which may be built in a production facility in series production and which can be transported to the site where it produces energy. The container may, for example, have a cylindrical or a rectangular block form.

The size and the dimensions of the container depend on the maximum power level of the nuclear reactor which is placed near the bottom and of the heat exchanger which is placed near the top of the container. The reactor and the heat exchanger are connected by riser and down-corner channels. In between the reactor and heat exchanger are two upper coolant plenums. There are provided a first high temperature upper coolant plenum for hot coolant from the core and that flows to the heat exchanger, and a second low temperature upper coolant plenum for cooled-down coolant from the heat exchanger. There is provided a third low temperature lower coolant plenum that is positioned below the core, through which the cooled-down coolant flows before entering the core.

The leak tightness of the connections of the down-corners to the low temperature upper coolant plenum is guaranteed because the temperature at the outsides of the connections is lower than the solidification point of the coolant;

B. The BBR has prismatic fuel elements which are stacked and placed side by side. There are vertical grooves along the vertical edges at the corners of the vertical outer planes of the fuel elements which form the coolant channels. The horizontal cross sections of the fuel elements fill the horizontal plane totally with the exception of the coolant channels. The BBR fuel is uranium dioxide. The fuel has a rather high initial uranium enrichment. A typical value for the initial fuel enrichment is 20% which facilitates a high burnup of about 100 MegaWattdays per kilogram heavy metal without refuelling. The initial enrichment may vary between 10% and 30% by which the burnup may decrease or increase, respectively. The refuelling period being equal to the operating period may count many years e.g. 20 years after which the reactor core is replaced in one batch. The reactor core can be replaced in one whole block as well.
C. The excess reactivity during the whole operating period of the reactor is nearly flat and less then about 1.3% above zero. This feature is obtained by applying spherical burnable neutron poison particles e.g. boron carbide. These particles are dispersed homogeneously over the fuel elements. In case of the 20% enriched fuel and pure ¹⁰BC₄ a typical value for the radius of the burnable particle is about 0.5 millimeter;
D. The containment function of the reactor core is guaranteed by the fact that the solidification point of the coolant is higher than the outside temperature of the reactor container under any possible circumstances;
E. The reactor core is surrounded on all sides by neutron reflectors which in their turn are surrounded by (a) thermal isolation layer(s). This construction facilitates a large temperature gradient between the core and the outer surroundings viz. the reactor container. The consequence is that before reactor starts up and before the primary system can be filled with the liquid metal coolant, the primary system has to be heated up from the inside. For this purpose dry vertical channels are provided which end underneath the thermal isolation near the container bottom where the temperature is lower than the solidification point of the coolant. At the bottom these channels are connected. They make a U-turn. To heat up the primary system heating elements, for example heating wires as primarily used in this description, are pulled into these channels. In principle, the heating elements could be incorporated directly in the reactor, without using channels in which said elements are placed. However, the use of separate channels is preferred;
F. The primary system is free of maintenance because it does not contain any active components with the exception of a fine reactor control system. This feature is realized by making use of natural convection cooling. The control system contains moveable neutron absorbing material e.g. control rods which are placed in dry vertical channels which end underneath the thermal isolation near the container bottom where the temperature is lower than the solidification point of the coolant. These channels are placed near the reactor core in the outer reflector;
G. The reactor coolant does not need any cleaning during the operating period. The corrosion resistance of the used construction materials being only graphite is extremely high because the solubility of graphite in the applied coolant, e.g. liquid tin under reactor temperature conditions is extremely low. Consequently the graphite material displacement from hot areas in or near the reactor core towards cold(er) areas of the primary system is negligible because of the selection of the liquid metal coolant being liquid tin. Other suitable liquid metals are lead and bismuth. A mixture of two or more of these metals may be used as well. All these metals have in common that they do not react with the graphite forming the respective carbide.

3) The BBR can be remotely surveyed which is feasible, because the reactor is extremely forgiving, self controlling and fail safe, because all reactivity coefficients are negative by which the fission process extinguishes itself in case an unforeseen event occurs.

4) A nuclear power plant may have only one BBR or more then one BBR. That means that one Nuclear Island or more than one Nuclear Islands may drive one Turbine Island. In the latter case the BBRs and its Nuclear Islands have the Turbine Island in common.

Hereafter, the invention will be described with reference to the drawing.

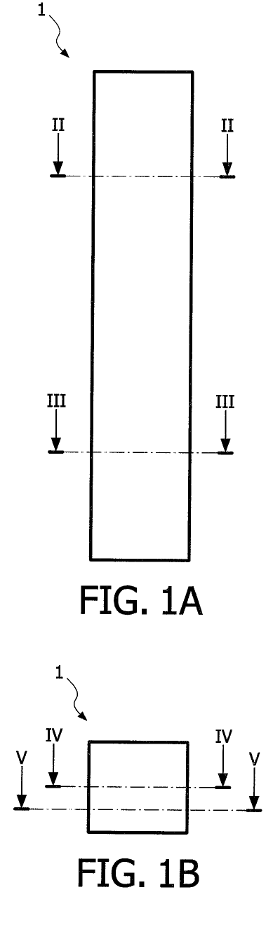

FIGS. 1A and 1B show a schematic side view and top view, respectively of the reactor according to the present invention.

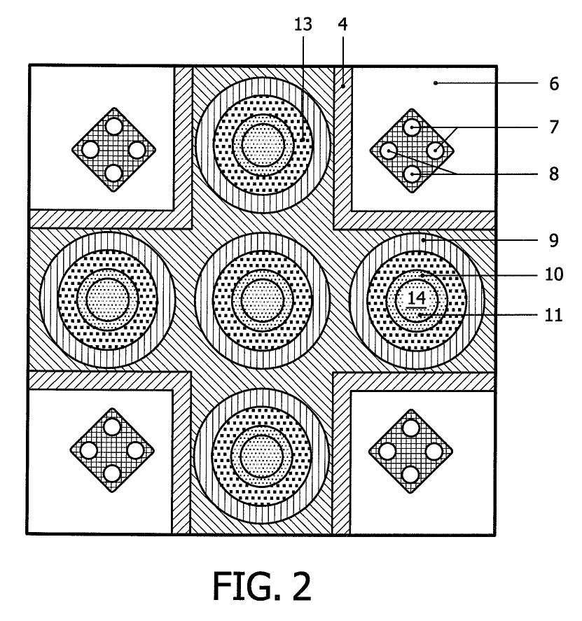

FIG. 2 shows a top view at cross section II-II.

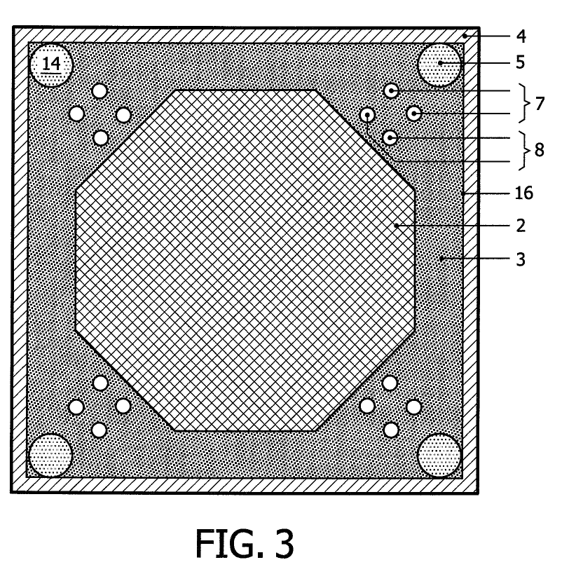

FIG. 3 shows a top view at cross section III-III.

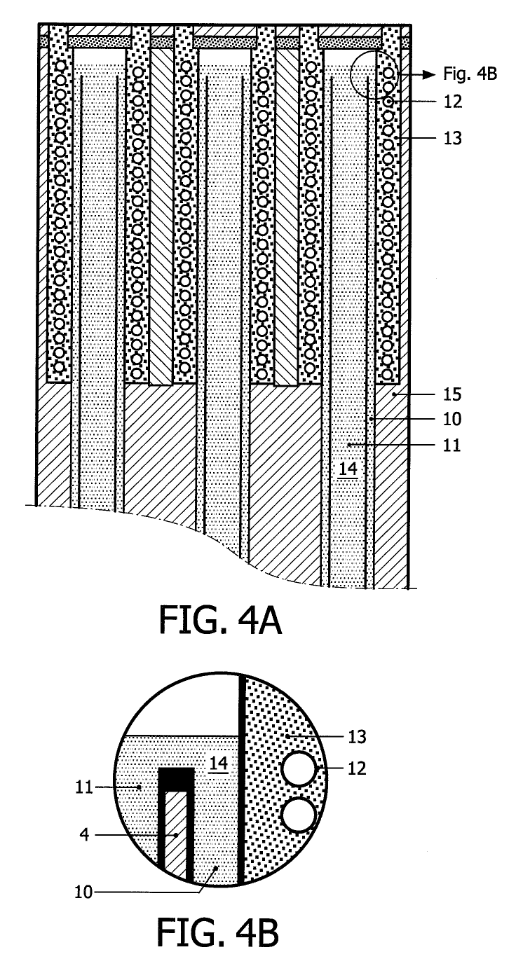

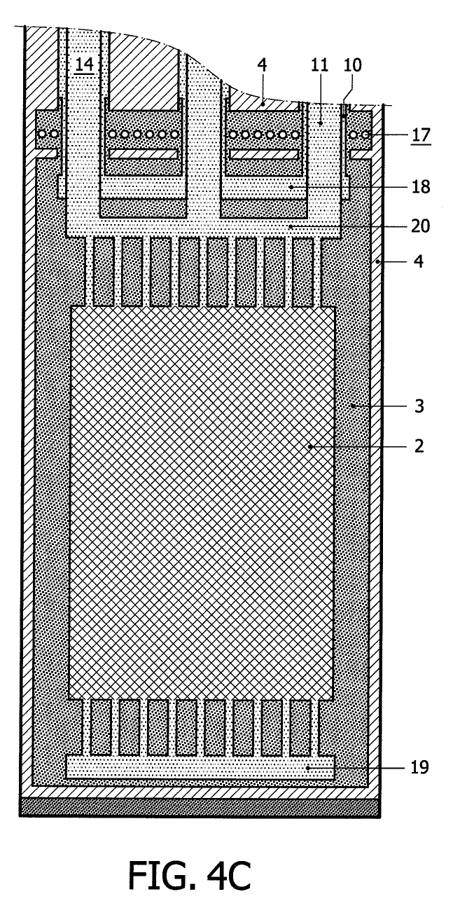

FIG. 4A shows a cross section IV-IV at the upper part of the reactor.

FIG. 4B shows an elevation of a part of FIG. 4A.

FIG. 4C shows a cross section IV-IV at the lower part of the reactor.

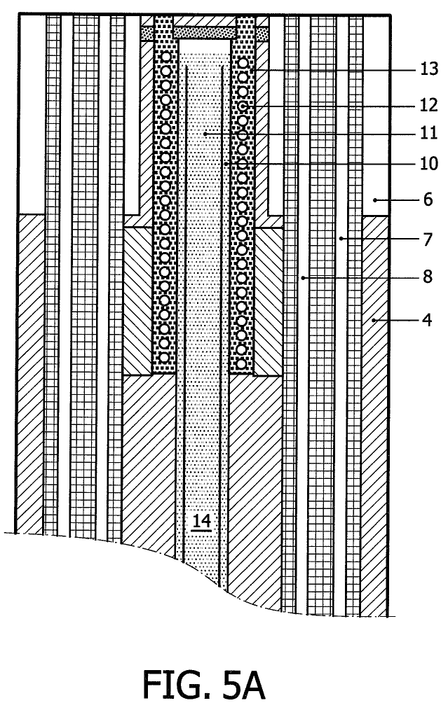

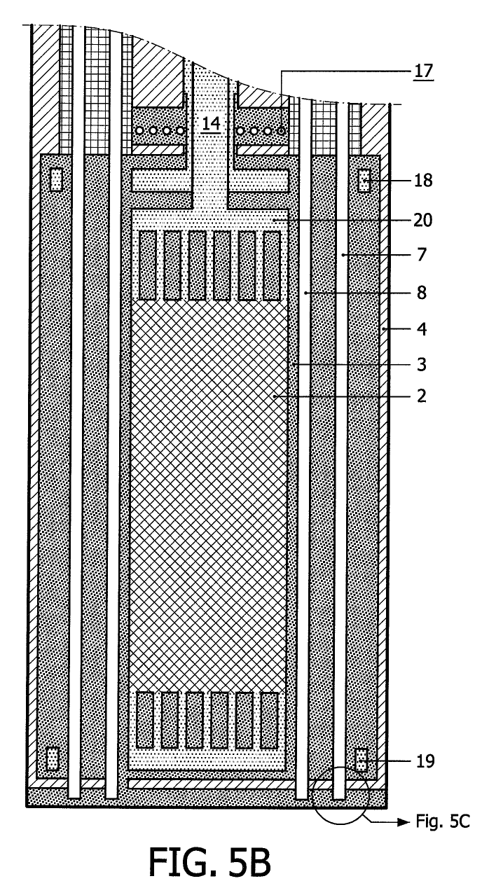

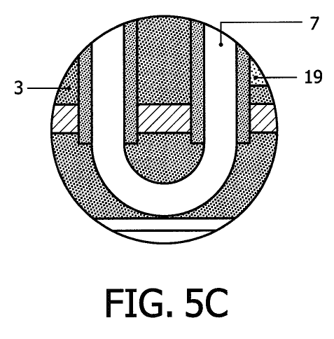

FIG. 5A shows a cross section V-V at the upper part of the reactor.

FIG. 5B shows a cross section V-V at the lower part of the reactor.

FIG. 5C shows an elevation of a part of FIG. 5B, rotated over 45° along a vertical axis in the plane of the drawing.

The same parts are indicated in the description and in the drawing with the same identifications or reference numerals. Sizes of reactor parts are given by way of example only. The invention is not limited to such sizes and measures.

The name of the reactor. Building Block Reactor (BBR), is derived from the feature that many such nuclear reactors can be installed in parallel to form one large Nuclear Power Plant. However, stand-alone applications of a single BBR in combination with an application for process heat or a Turbine Generator are not ruled out.

The BBR, in fact the primary system viz. the reactor, the steam generator as well as its control and (cold) shut-down equipment, is placed in one large container. A number of BBRs may have a Turbine Generator as well as the Biological shielding in common. Both these systems are external.

The typical size of the container is 4×4×15 meter. This size mainly depends on the power level and the applied power density. Smaller or larger sizes are possible.

The typical height of the reactor core is 5 meter. The typical diameter of the reactor is 3 meter. Different sizes of the reactor are possible as well. The core is either square, hexagonal, octagonal, cylindrical or has a form which resembles one of these. The typical power being produced by the reactor core is 30 MWₜₕ. Smaller or larger power levels are possible. Consequently the power density is about 0.67 MWₜₕ/m³. Typically the power density is between 0.25 and 10 MWₜₕ/m³. The typical thickness of the outer reflector of the reactor core is 0.50 meter and of the thermal isolation at the outside of the reflector is typically 0.20 meter.

Because of its size, containers containing the whole primary system (including the nuclear reactor and its fuel elements, however without coolant), can be transported by train, ship or special vehicle.

FIG. 1A shows a schematic side view of the reactor 1. The core (not visible in this figure) is positioned at the bottom part of the reactor 1, whereas the steam generator area (not visible) (and other parts, as will be identified hereafter) are positioned at the upper part. FIG. 1B shows a schematic view from above on the reactor 1.

The FIGS. 2 and 3 show the horizontal cross sections of the BBR in case of an octagonal reactor core 2 in a rectangular block container (the housing of the reactor) with in each corner four vertical channels or channels 7, 8, at II-II and III-III, respectively, as indicated in FIG. 1A. The FIGS. 4A, 4B and 4C, and 5A, 5B and 5C show the vertical cross sections of the BBR in case of an octagonal reactor core 2 in a rectangular block container at IV-IV and V-V, respectively, as indicated in FIG. 1B. Two channels 8 for the reactor control system and two channels 7 for the initial heat up before reactor start-up are provided. Only one channel 8 per corner might be sufficient as a guide tube for reactor control, however in that case there is no back-up for this important system. The container may have any other form e.g. cylindrical, square etc. The lower part of the container is occupied by the nuclear reactor. The upper part by the heat exchanger, e.g. the steam generator.

The BBR is cooled by a molten metal which has the characteristic of low neutron absorption, low activation, a rather high melting point (viz. above 100° C., the maximum temperature on the outside of the reactor container) and that the coolant does hardly dissolve the moderator material at rather high temperatures (above 500° C.). Tin (Sn) is a suitable candidate for the coolant and graphite for the moderator material. Other suitable materials may be lead, bismuth or mixtures of said metals mentioned and/or other metals.

The materials tin and graphite will be used as exemplary materials in the following paragraphs. The coolant flows through coolant channels in the core and in the lower and upper reflector. An exemplary value for the coolant volume fraction of the reactor core is 3.5%. It suitably is between 1 and 10%, preferably between 2 and 7%, more preferably between 3 and 5%. Smaller or larger coolant volume fractions are possible as well. A typical value for the coolant flow is 0.06 m³/s. Smaller or larger values for the coolant flow are possible as well. A typical value for the cycle period of the coolant is 3½ minute. Smaller or larger cycle times are possible as well. Because of the long cycle time the reactor power can only follow changes in the electricity demand slowly and to a limited extend. If necessary the heat produced may be dumped.

The reactor core may have inner reflectors and has in any case reflectors 3 on all its outside planes. The reflectors contain a number of channels which are dry (no coolant in it) and leak tight. These channels 7,8 are made from graphite or from carbon fibre tubes. All channels start at the top in a instrumentation area 6, which is shown in the figure in a corner near the top of the container, pass upper plenums 18,20, the upper reflector, the reactor core 2, the lower reflector, the lower plenum 19 successively and pass the lower thermal isolation 4 near the bottom. They preferably are made of one piece. Below the lower thermal isolation 4 the temperature is always lower than the melting point of tin by which no ingress of molten tin 14 into the channels can occur. Near the bottom the heat-up channels 7 are in pairs of two connected by U-turns as is shown in FIG. 5C. These channels are used for the electrical heat up during reactor start up and may during the reactor operation contain transportable in-core probes e.g. thermocouples, neutron detectors. The remainder of the channels 8 contain control and shut-down elements or rods which are used for the slow power control of the reactor during normal operation as well as for cold shut-down. Some active power control is necessary in order to adjust the reactivity during the operating period. It may be left out in future generations of BBRs when experience is gained with the reactivity behaviour as function of burnup. The reactor power level is further controlled by changes in the coolant water flow to the steam generator (secondary system). If the power cannot be used during a short period of time, then it can be dumped. The control and shut-down element drives are placed in the instrumentation area 6 near the top of the container.

In order to maximize the power output, the thickness of the outer reflector 3 is relatively small. A thermal isolation 4 between the neutron reflector 3 and the wall of the container is applied to avoid an unacceptable large power flow to the container wall which would otherwise heat up this wall too much. A coating with a neutron absorbing material 16, for example ¹⁰B₄C, is applied everywhere between the neutron reflector and the thermal isolation in order to minimize the activation by neutrons of the isolation 4 and the container wall. During the normal operating condition the wall has a typical temperature of 80° C. A person skilled in the art is able to determine the required amount of isolating material to obtain the mentioned outer wall temperature. This temperature is much lower than the melting point of tin, viz. 232° C. Because of this solidifying characteristic no material can leak from the reactor core into the environment. The containment function of the nuclear reactor is based on this phenomenon.

The reactor core has prismatic fuel elements. In fact there is no necessity for an internal reflector. The prismatic fuel elements are stacked. The horizontal cross section of each fuel element is a hexagon. Other forms which fill a plane mainly totally, like squares or triangles, are possible as well. The horizontal lengths of the sides of the hexagons are typically 0.1 meter. The height of the prismatic fuel element is typically 0.5 meter. Other dimensions may be applied to the fuel elements as well. The reactor core with prismatic fuel elements is cooled by a number of coolant channels. There are two possibilities. Either each fuel element has a coolant channel. For instance through its centre line. Or the vertical edges at the corners of the hexagons posses a concave form in such a way that at these corners vertical coolant channels are formed when the fuel elements are placed side by side. A typical value for the radius of a coolant channel is 0.02 meter. Smaller or larger values for the radius are possible as well. The fuel elements contain the coated fuel particles as well as the burnable poison particles. The coated particles may either be concentrated in compacts or distributed homogeneously over the fuel element. The maximum temperature of the fuel element is typically 1200° C. Its average temperature is typically 1000° C. Lower or higher average temperatures in the range between 500 and 1300° C. may be applied. The maximum temperature is always below the temperature at which the coated particles disintegrate, viz. 1600° C.

The coolant channels are located between the lower cold plenum 19 and the upper hot plenum 20. They pass successively the lower reflector, the reactor core and the upper reflector. If the coolant channels are located vertically then through these coolant channels the coolant flows upwards in the case the driving force is natural circulation. The coolant flow may be stimulated by applying a pump and then horizontal coolant channels may be applied as well. For instance an EM-pump (Electro Magnetic pump). It is assumed in the following that the coolant channels are located vertically, that the coolant flow is upwards and that the driving force is natural circulation.

The coolant 14 is heated up in the vertical coolant channels of the reactor core. It flows upward because of its decreasing density. It is collected in a hot plenum 20 above the core. From there it flows through one of the riser channels 11 upwards to the top. In the figures with the cross sections a number of five riser channels 11 has been assumed. Smaller or larger numbers are possible as well. At the top the direction of the flow is reversed. The coolant 14 flows then downwards through the annulus between riser channels 11 and down-corner channels 10 and is cooled by the heat exchanger, e.g. the steam generator 9, 12. The heat exchanger 9, 12 is located in the upper part of the container. These down-corner channels 10 are connected to the upper cold plenum 18. To avoid leakage of molten tin 14 through this connection, the upper cold plenum is isolated thermally by a layer of thermal isolating material and by a layer of graphite. The space between the top of the upper plenum and the bottom of the heat exchanger(s) is cooled by using the cold water 17 from the sump of the condenser before it is reheated by the re-heater. From the upper cold plenum 18 the molten tin coolant 14 flows through one of the four other down-corner channels 5 to the lower cold plenum 19. Each down-corner channel 5 is located in one of the corners of the outer reflector. The lower cold plenum is located below the reactor. The coolant flow is in this case completely passive, it is caused by gravitation and it is called natural circulation. Orifices between the plenum and the parallel reactor coolant channels may be applied to avoid swings in the coolant velocity or Ledinegg instabilities.

The BBR container may either be surrounded by an external biological shield or it is placed in an underground vertical vault or silo. There is a gap between the BBR container and the wall of the biological shield or of the silo. If during an accident the normal cooling of the reactor fails then the reactor container is cooled by natural phenomena, for example by surrounding water or in case of a dry solution by circulation of air through the gap between the container and the silo.

The combination of the materials liquid tin and graphite is in any case favourable. The design is such that the liquid tin in the primary system is only in contact with graphite and not with any other material. Consequently graphite is being used for the reflectors, possibly in-core and in any case at the outside, for (the outside of) the fuel elements and as construction material for the risers 11, down-corners 5, 10, plenum 18, 19, 20 surfaces etc. Advantages of liquid tin are that:
it does not chemically react with carbon and consequently it does not form a carbide;
the solubility of graphite in liquid tin under reactor temperature conditions is extremely low;
its melting point is relatively low, viz. 232° C.;
its boiling point is very high, 2687° C.;
its cross section for thermal neutron capture is low as well, viz. 0.625 barn at 0.0253 eV.

A draw-back is that tin activates to some extend. However after decommissioning the activated tin may be used for a new BBR.

Literature shows that for the temperatures involved the solubility is so low that deposition of graphite from the hot places towards the cold ones is negligible. Even after the life time of the reactor of 20 years. There is no self-wetting of the graphite by the liquid tin. The published contact angle or wetting angle determined with the sessile drop method is 150″. Consequently tin does not penetrate small pores in the graphite as long as there is no or only a low pressure applied.

The temperatures in the reactor, the coolant and the outer wall of the container depend on the reactor condition. An abnormal condition may result after the loss of coolant in the secondary system, e.g. coolant water in the steam generator. The loss of the molten coolant from the reactor is impossible because the temperature at the container wall is always lower than the melting point of the coolant. In case of tin: 232° C.

The following conditions and heat flows may occur during the life time of the BBR:
the increase of the reactor temperature before reactor start-up by heating elements;
the normal operating condition of the plant including the temperature gradient in the fuel element, the natural convection cooling of the reactor during normal operation, the parasitic heat transfer between the concentric riser and down-corner channels, the heat transfer between the upper down-corner channels and the steam generators, and the parasitic heat transfer between the reactor core and the container walls;
the passive reactor cooling after a loss of coolant incident in the secondary system e.g. loss of water coolant from the steam generator.

The start-up of the reactor forms the start of its operation period. Before the start-up can take place the reactor as well as its primary cooling system have to be filled with liquid tin. In order to avoid the solidification of the liquid tin both the reactor core 2 and its cooling system are heated in advance. To this extend heating elements, for example heating wires, are pulled into the heating channels 7. Each wire produces a certain heating power, for instance 10 kiloWatt. If the power density of the wire in the core is about 1 kW/m, then it takes about three weeks before the reactor reaches a temperature of 300° C. The heating elements are removed as soon as the reactor becomes critical and the nuclear power production takes over the heat production. They may be replaced by a TIP-system (transportable in-core probes), by which axial temperature curve and neutron fluxes can be measured.

During normal operation the coolant is heated up in the reactor region which is located near the bottom of the container. The coolant reaches a temperature of 800° C. at the top of the reactor. The hot coolant has a lower density than the cooler coolant of 500° C. at the bottom of the reactor and in the down-corners underneath the steam generators. The average temperature of the reactor core is in this case about 1000° C. There is a large degree of freedom in the selection of all these temperatures. They may be higher or lower than has been mentioned in this example.

The coolant temperature in the riser has a constant value of 800° C. if measures have been taken to make the parasitic heat flow between the concentric riser channel and the upper down-corner channel negligible. At the top of the container the direction of the flow is reversed. In the down-corner the molten tin is cooled by a heat exchanger, wherein for example steam is generated in an adjacent steam generator which surrounds the piping of the primary system. After the heat exchanging area the coolant temperature is about 500° C. The temperature averaged over the upper down-corner is 650° C. The difference in density between the high and low temperature coolant may facilitate a natural convection cooling of the reactor core. The driving force is in this case completely passive. It is gravity.

A typical height for the heat exchanging area is 5 meter. Other values for this height may be applied and may depend on the amount of heat which is transferred as well of the coolant type in the secondary system, e.g. water/steam or another liquid (metal) or a gas.

The coolant velocity in the reactor coolant channels, in the riser and down-corner channels depends on the total friction between the coolant and the walls as well as on applied orifices and on in-flow and out-flow losses caused by the sudden strictures and dilatations between the coolant channels on one hand and the plenums on the other. In order to avoid coolant flow instabilities between a large number of parallel channels the flow is turbulent. If necessary, orifices at the channel entrances may be applied. The desired coolant velocity is reached by the precise dimensions of the flow constrictions in the primary system.

An example is given for a BBR with a steam generator. In order to avoid graphite corrosion in case of steam leakage from the steam generator a coating is applied to the outer surface of the upper down-corner 10 e.g. siliconcarbide (SiC). To improve the heat transfer between the down-corner 10 and steam generator 9, 12 the annular space 13 which is in between may be filled with small grains having both a good heat conduction and a high melting point, e.g. iron, tungsten or a mixture of such metals. The heat conducting characteristics may be adapted to the desired heat flow in order to avoid possible dry-out phenomena in the steam generator 9, 12. Another function of the annular space is to facilitate depressurization of the steam generator 9, 12 in case of rupture of the steam generator wall. The depressurization takes place through the grains. Because of this construction steam can not be in direct contact with the carbon fibre outer wall of the down-corner and it can not corrode that wall in such a case. The SiC-coating prevents such corrosion.

The steam generator 9, 12 may be a coiled tube or a vessel. In the latter case the steam generator has the form of a long tubular cylindrical vessel and is consequently of a non-conventional type. The steam is then produced at the inner steam generator wall.

After a loss of coolant (water) in the secondary system the power can not be transferred from the liquid tin any more. Consequently the coolant temperature and afterwards the reactor temperature being 1000° C. on average starts to rise. The negative temperature dependent reactivity coefficient of the reactor core stops the fission process as well as the nuclear fission power production. However the temperature in the reactor further increases because of the decay heat of the radioactive fission products. The average reactor temperature results from the difference between decay heat power production and the power flowing from the reactor core through the container wall towards the environment. The heat is transferred to the environment through a combination of phenomena, being heat conduction, heat radiation and natural convection of air. The maximum temperature in the reactor core may reach a value of 1400° C. which is lower than the temperature of 1600° C. at which the integrity of the coated particles starts to deteriorate. The maximum temperature may be reached after about 30 days. The length of this period depends on the average power density of the reactor core and of the thickness of the thermal isolation 4 applied between the outer reflector and the wall of the container. After the heat-up period the temperature decreases slowly until the original average reactor temperature of 1000° C. is reached. At that point the reactor becomes critical again and produces just the power to keep its temperature constant at 1000° C. during a nearly indefinitely long period of time. Consequently once the reactor is in operation it stays hot during its whole operating period.

A number of the nuclear power reactor characteristics depend on neutronics. A couple of conflicting criteria are involved:
The reactor core volume should be small in order to fit in a transportable container. However a smaller core implies a higher power density;
The thickness of the outer reflector of the reactor should be as thin as possible for the same reason. However the power density should be as homogeneous as possible anywhere in the core which requires a thicker outer reflector;
The neutron economy must be excellent in order to reach a high burnup which requires a low neutron leakage and consequently a large reactor core;
The temperature dependent reactivity coefficient of the reactor core must have a (large) negative value under all reactor circumstances;
The reactor should have a long operating period which facilitates a batch wise refuelling and consequently a burnup which is as high as possible;
The reactor should have a low power density as possible and consequently low ¹³⁵Xe and ¹⁴⁹Sm concentrations (parasitic neutron absorbing fission products) during normal operation. Further a low power density results in a low decay heat production after an unplanned shut-down and subsequently in a low rise of the core temperature;
The excess reactivity which has to be controlled by a control system, should be as small as possible during the whole operating period.

Because a number of these criteria are conflicting design choices have to be made. Consequently the following solution is exemplary. Other design choices result in comparable solutions which may function equally well. Where that is relevant the design margins have been specified between brackets.

According to an exemplary embodiment, a single BBR core contains 2.3 ton 20% (10%-30%) enriched uranium in the form of coated TRISO particles with a 002-kernel of 0.5 mm (0.4 mm-0.6 mm) in diameter, embedded in prismatic fuel elements. The coated particles either may be in fuel compacts or may be homogeneously distributed over the fuel elements.

The coated particles prevent the release of fission products up to a temperature of about 1600° C. At the start-up of the reactor the new core contains 4-5 kilogram. ¹⁰Boron burnable poison in the form of ¹⁰B₄C micro-spheres each with a radius of about 0.5 millimeter (22.5 kilogram natural Boron with radius of about 1.7 millimeter). With such a fuel the curve of the reactivity as a function of burnup and without any reactor control is nearly flat. The swing between the expected maximum and minimum value in the excess reactivity is about 1.3%. Of course the minimum value is above zero which is a condition for the reactor to be critical. The flat reactivity characteristic is obtained by the way the burnable poison particles are burned with increasing burnup. The particles are mainly burned away from the outside by the thermal neutrons in the reactor. At the same time they are burned away more or less uniformly by the epithermal and fast neutrons. It is this ratio of the captured epithermal/fast neutrons and the thermal neutrons (which is changing during the burnup of the reactor) which results in the special flat behaviour of the excess reactivity.

The estimated temperature dependent reactivity coefficient is about −3.5 percentmille per centigrade. This characteristic brings a future BBR without active reactor control within perspective. There are three phenomena all contributing to the negative coefficient, viz. the Doppler effect of the resonances in the absorption and possible fission cross sections of the fuel and the coolant, the eta-effect caused by the hardening of the neutron spectrum at a higher core temperature and the self-shielding effect of the thermal neutrons of the ¹⁰B₄C which depends on the neutron spectrum as well.

The calculated burnup of the BBR core is about 100 MegaWattday per kilogramme heavy metal.

The BBR has an ultimate simple design and is extremely safe. This safety is reached by a combination of the following points:
A limited excess reactivity (maximally 1.3%);
A negative temperature coefficient;
The feature of the completely passive cooling of the core after a loss of coolant incident;
A containment function which is based on the solidifying phenomenon of the coolant before it can reach the container wall.

Because of its extreme safety the BBR does not need any operating personnel. It is sufficient that the BBR is controlled by a computer system and is watched over by remote surveillance.

At the end of the operating cycle the BBR is refuelled. For this purpose first the liquid coolant is removed from the primary system and then all the systems above the upper reflector are removed with the exception of the dry vertical channels. Next the whole reactor core, the upper reflector and lower reflector are in its whole pulled in a special vessel. Such an operation is feasible because the graphite shrinks during the operating period. The shrinkage of the graphite (about 2% linearly) is caused by the fast neutron fluence and is just maximally at End of Life of the reactor core.

1. A nuclear reactor, comprising:
a reactor core,
neutron reflectors surrounding said core on all sides,
uranium oxide as reactor fuel, and
a cooling medium that is liquid at process conditions and solid at room temperature, wherein the nuclear reactor comprises a thermal isolation which is impermeable for the coolant, which is of a different material than the neutron reflectors and the coolant and which has a melting point higher than the temperature inside the reactor, such that the reactor core and the neutron reflectors are surrounded by the thermal isolation on all sides in order to provide a teak-tight containment near a wall of a housing of the nuclear reactor.

2. The nuclear reactor according to claim 1, wherein heating elements are embedded in the reflectors for heating at least the reactor core before start up of the reactor.

3. The nuclear reactor according to claim 2, wherein heating channels are embedded in the reflectors which contain the heating elements.

4. The nuclear reactor according to claim 2, wherein said heating elements are positioned in heat exchanging relation with the reactor core.

5. The nuclear reactor according to claim 1, wherein said cooling medium is comprised of tin (Sn).

6. The nuclear reactor according to claim 1, wherein a reactor core comprising uranium oxide is underlayed by a neutron reflector and in that a plenum comprising cooling medium is provided below said core.

7. The nuclear reactor according to claim 1, wherein a reactor core comprising uranium oxide is overlayed by a neutron reflector and in that a plenum comprising cooling medium is provided above said core.

8. The nuclear reactor according to claim 7, wherein a heat exchanger is provided at a higher position than the core, said reactor comprising a reactor core through which liquid cooling medium flows upwards from a relatively lower part to a relatively higher part of said core, taking up heat from the core, said reactor further comprising channels through which said cooling medium flows to said heat exchanger, exchanging at least a part of its heat with a secondary cooling medium in said heat exchanger, and comprising channels leading downwards from said heat exchanger to said relatively lower part of the nuclear core through which said cooled liquid cooling medium subsequently flows downwards.

9. The nuclear reactor according to claim 8, wherein said channels through which said cooling medium flows to said heat exchanger is comprised of a riser and a concentrically placed down-corner that is in heat exchanging relationship with said secondary cooling medium in said heat exchanger.

10. The nuclear reactor according to claim 8, wherein a plenum is situated between said core and said channel through which said cooling medium flows to said heat exchanger.

11. The nuclear reactor according to claim 8, wherein said channels leading downwards from said heat exchanger end up in an upper plenum that is provided above said core where the leak tightness of the connection between the channel leading downwards and the plenum is realized using the solidifying characteristic of the coolant.

12. The nuclear reactor according to claim 8, wherein said upper plenum above said core is provided with down-corner channels leading downwards and passing said core and end up in said lower plenum below the said core.

13. The nuclear reactor according to claim 8, wherein a thermally isolating material is provided around the reactor core and its neutron reflectors, allowing an amount of heat loss from the core through the reflector and said thermally isolating material towards the wall of the housing of the reactor, in such a way that the maximum obtainable temperature in the core is always less than 1600° C.

14. The nuclear reactor according to claim 8, wherein said nuclear core is comprised of stackable fuel elements, neighboring elements having close fitting surfaces, and comprising cooling medium channels in said elements or said surfaces such that a flow path for the cooling medium is obtained from the lower part to the higher part of said core which are connected to the cooling medium channels in said upper and lower neutron reflectors.

15. The nuclear reactor according to claim 11, wherein the cooling medium volume fraction of the reactor core is between 1 and 10%.

16. The nuclear reactor according to claim 15, wherein the cooling medium volume fraction of the reactor core is between 2 and 7%.

17. The nuclear reactor according to claim 16, wherein the cooling medium volume fraction of the reactor core is between 3 and 5%.
